(19) United States
(12) Patent Application Publication
(10) Pub. No.: US 2015/0199844 A1
(43) Pub. Date: Jul. 16, 2015

(54) TANGIBILIZATION OF GEOCODED DATA

(71) Applicant: Microsoft Corporation, Redmond, WA (US)

(72) Inventors: Andrés Monroy-Hernández, Seattle, WA (US); Henric H. Jentz, Seattle, WA (US); Timothy Regan, Cambridge (GB); Alicia Marie Edelman Pelton, Sammamish, WA (US); Jennifer Lauren Rodenhouse, South Pasadena, CA (US); Michal Lahav, Seattle, WA (US); Siân Elizabeth Lindley, Cambridge (GB)

(73) Assignee: Microsoft Corporation, Redmond, WA (US)

(21) Appl. No.: 14/152,983

(22) Filed: Jan. 10, 2014

(51) Int. Cl. G06T 17/05

(52) U.S. Cl. CPC G06T 17/05

(57) ABSTRACT

Data points that include geolocation data are obtained. Frequency values are determined that depict frequencies of sets of the data points that are associated with respective geolocations represented by the geolocation data, and the frequency values are normalized. A georepresentation of the data points is generated, as a tangible 3-D model, using the geolocation data to determine location perspective of the data points on the 3-D model for a mapping of the data points to the 3-D model, and using the normalized frequency values to determine sensory attributes of portions of the 3-D model at locations of the respective mapped data points on the 3-D model, the sensory attributes representing frequency value ranges.

### BACKGROUND

Users of electronic devices are increasingly using geolocation data for decision-making activities, as well as many other types of uses. Large amounts of geolocated data may be difficult for a typical user to understand. Visualization techniques for such data have included histograms, charts, maps, and plots printed on paper or displayed a computer screen.

### SUMMARY

According to one general aspect, a system may include a data tangibilization engine that includes a data acquisition component configured to obtain a plurality of data points that include geolocation data associated with each respective obtained data point. A frequency determination component may be configured to determine a plurality of frequency values depicting frequencies of sets of the obtained data points that are associated with respective geolocations represented by the geolocation data. A normalization component may be configured to normalize the plurality of frequency values. A model generator may be configured to generate a tangible three-dimensional (3-D) model using the geolocation data to determine location perspective of the data points on the 3-D model for a mapping of the data points to the 3-D model, and using the normalized frequency values to determine heights of raised portions of the 3-D model at locations of the respective mapped data points on the 3-D model.

According to another aspect, data points for social media data may be obtained, the data points including geolocation data associated with each respective obtained data point. Frequency values depicting frequencies of a first predefined attribute of the obtained data points may be determined The frequency values may be normalized. Further, a georepresentation of the social media data may be generated, as a tangible three-dimensional (3-D) model using the geolocation data to determine location perspective of the data points on the 3-D model for a mapping of the data points to the 3-D model, and using the normalized frequency values to determine sensory attributes of portions of the 3-D model at locations of the respective mapped data points on the 3-D model, the sensory attributes representing frequency value ranges.

According to another aspect, a computer program product tangibly embodied on a computer-readable storage medium may include executable code that may cause at least one data processing apparatus to obtain a plurality of data points for social media data, the data points including geolocation data associated with each respective obtained data point. Further, the data processing apparatus may determine, via a device processor, a plurality of frequency values depicting frequencies of sets of the obtained data points that are associated with respective geolocations represented by the geolocation data. Further, the data processing apparatus may normalize the plurality of frequency values. Further, the data processing apparatus may generate a georepresentation of the social media data, as a tangible three-dimensional (3-D) model using the geolocation data to determine location perspective of the data points on the 3-D model for a mapping of the data points to the 3-D model, and using the normalized frequency values to determine sensory attributes of portions of the 3-D model at locations of the respective mapped data points on the 3-D model, the sensory attributes representing frequency value ranges.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. The details of one or more implementations are set forth in the accompanying drawings and the description below. Other features will be apparent from the description and drawings, and from the claims.

### DRAWINGS

FIG. 1 depicts an example tangibilized georepresentation of social media data.

FIGS. 2A-2C depict example georepresentations of social media data.

FIG. 3 is a block diagram illustrating an example system for generating tangibilized georepresentations of social media data.

FIGS. 4A-4C are a flowchart illustrating example operations of the system of FIG. 3.

FIGS. 5A-5B are a flowchart illustrating example operations of the system of FIG. 3.

FIG. 6 is a flowchart illustrating example operations of the system of FIG. 3.

FIGS. 7A-7D depict an example technique for generating the tangibilized georepresentation of FIG. 1.

### DETAILED DESCRIPTION

### I. Introduction

Large corpora of geolocated data may be cumbersome for users to understand. Example techniques discussed herein may convert large corpora of geolocated data into three-dimensional scale (3-D) models of geographic entities (e.g., the earth, a country, etc.), where values such as frequency counts of data points in specific geolocations may be represented by the normalized height of raised relief. It is to be understood that example techniques discussed herein are not limited to data originating in a geographical environment, as various types of similarity and distance metrics may be used on many types of data to convert such raw data into points that may be virtualized to geolocation-type data (e.g., similarities of documents, similarities/differences among various entities, etc.). For example, in this context, “relief points” may refer generally to points that appear to be raised, or located at a higher elevation than other points in close proximity to such relief points. For example, a 3-D map of an area may be generated to visually provide a tangible (e.g., tactile) representation of frequency counts of data points using the normalized height of raised relief in the geolocations associated with the respective data points.

For example, such a 3-D map may include a substantially spherical shape (e.g., a globe shape), a flat, or slightly elliptical map with tangible data, and/or any other shape that a user may desire, for a tangible experience of the data.

Example techniques discussed herein may convert data into a tactile experience. For example, such a tangible representation may enable users to experience geocoded data through the sense of sight and touch, which may provide various understanding opportunities for, at least, novices and people with visual impairments.

In accordance with an example embodiment, geocoded data may be converted into a 3-D printed model, based on an input that includes geolocation data (e.g., latitude and longitude values) for a plurality of data points.

For example, the geolocation data latitude and longitude values may be rounded based on a parameter that determines the desired granularity of the model. Such a granularity parameter may determine the number of decimal values in the latitude and longitude values, where more decimal values may represent higher granularity and thinner relief points, for example, in a 3-D printed model.

For example, for each unique latitude-longitude pair, a frequency of occurrences of the pair, over the data points, may be calculated (e.g., with approximations such as rounding latitude and/or longitude values). The frequency may then indicate the number of rows in the set of data points that have the same approximate (e.g., rounded) geolocation value. This frequency may be normalized by applying a logarithmic function to attenuate drastic changes in values, which may then provide a machine readable file with values that may include, at least, frequency, latitude, and longitude values. For example, “drastic” changes in values may result from frequencies of entities that appear to be “outlier” values (e.g., a frequency of transmissions generated by a “bot” device configured to transmit a continuous stream of messages from a particular geolocation, during a particular time interval).

For example, a spherical digital model may be generated using the frequency value as the height of a mountain-like representation, and the latitude-longitude value to determine the location of such a “mountain.” For example, the shape of the “mountain” may be smoothened using example 3-D smoothening techniques (e.g., providing a shape of a cylinder rather than a mountain), or may be left raw. For example, “mountains” may depict geolocation areas associated with larger frequency values than for geolocation areas depited as “valleys” (e.g., geolocation areas with lower, or substantially lower, heights, with respect to the “mountains” on the model).

For example, the spherical model may be converted into a standard stereolithography (STL) CAD file format. For example, such a STL file may be sent to a 3-D printer using printing tools (e.g., WINDOWS 8 3-D printing tools).

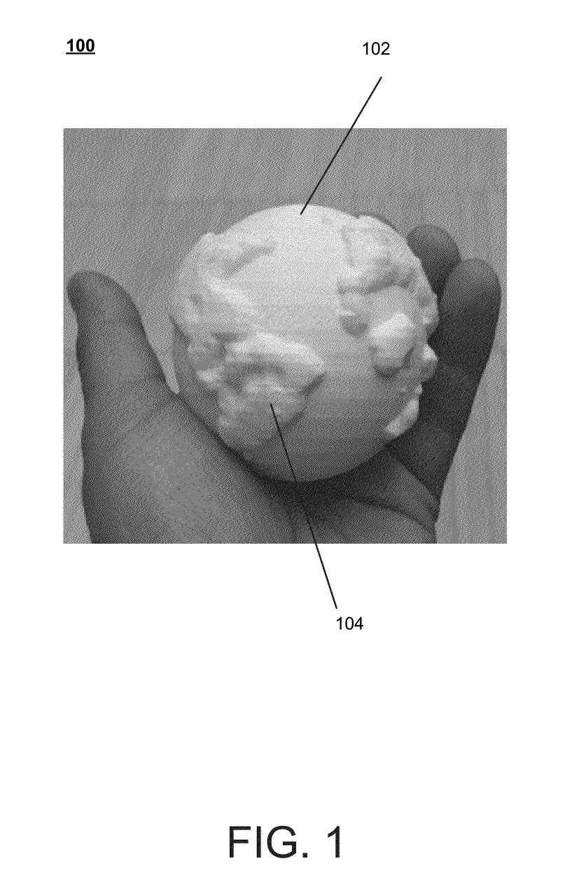

FIG. 1 depicts an example tangibilized georepresentation of social media data. It is to be understood that example techniques discussed herein are not limited to social media data, but may be used for any with any type of data (e.g., substantially large amounts of such data) that may have location information associated with it (e.g., data from Global Positioning System (GPS) enabled mobile phones, and other “location-aware” devices, as well as entities that are associated with “distance” or “similarity” information).

As shown in FIG. 1, a spherical globe 104 has raised portions 104, depicting frequencies of social media entities at a particular time interval. For example, the raised portions may be generated as relief points on a 3-D model that is output from a 3-D printer, in accordance with example techniques discussed herein. For example, the raised portions 104 as shown on the spherical globe 104 of FIG. 1 depict frequencies of TWEETs (e.g., messages using TWITTER) originating from various global geolocations on Jan. 1, 2013. For example, the globe 104 of FIG. 1 may physically represent the earth, with the relief points tangibly depicting the various frequencies, providing a tactile experience of geocoded data for a user. As shown in the example of FIG. 1, approximately 5 million geotagged TWEETs posted on New Year's Day of 2013 may be realized as a “data sculpture” that may be held in a user's hand.

For example, a user may use such a tactile experience to observe that geographical areas such as the country of Africa may have a substantially large population, but may have almost no TWEET activity over a particular time interval. As another example, the country of Japan may be observed to have a drastically large number of originated TWEETs, which may lead to a user discovery of an automated device (e.g., a “bot”) generating a continuous stream of TWEETs over a particular time interval.

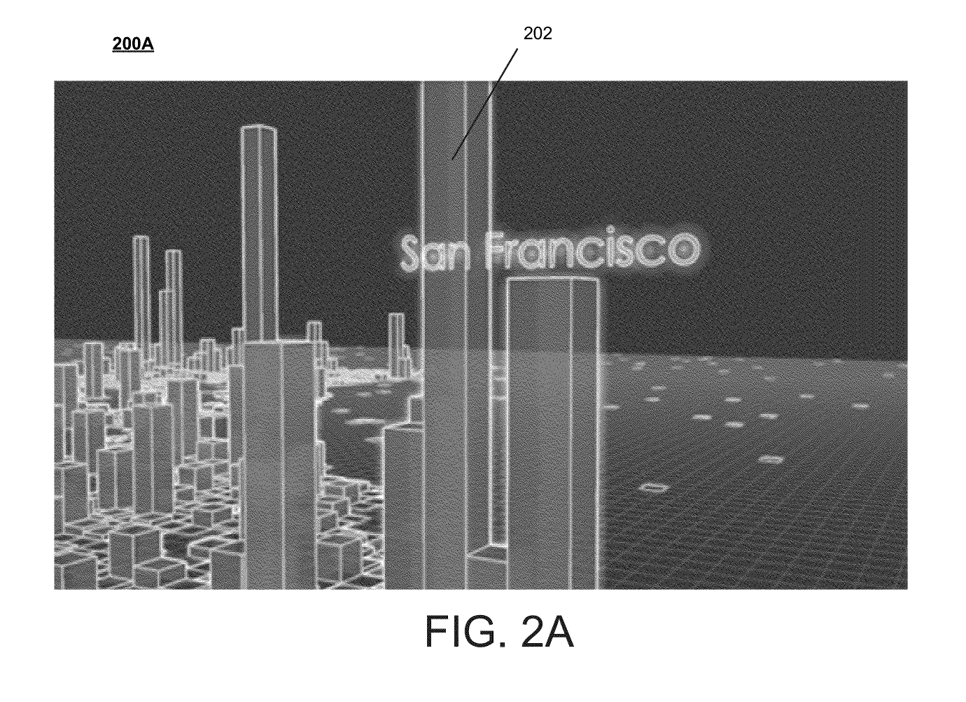

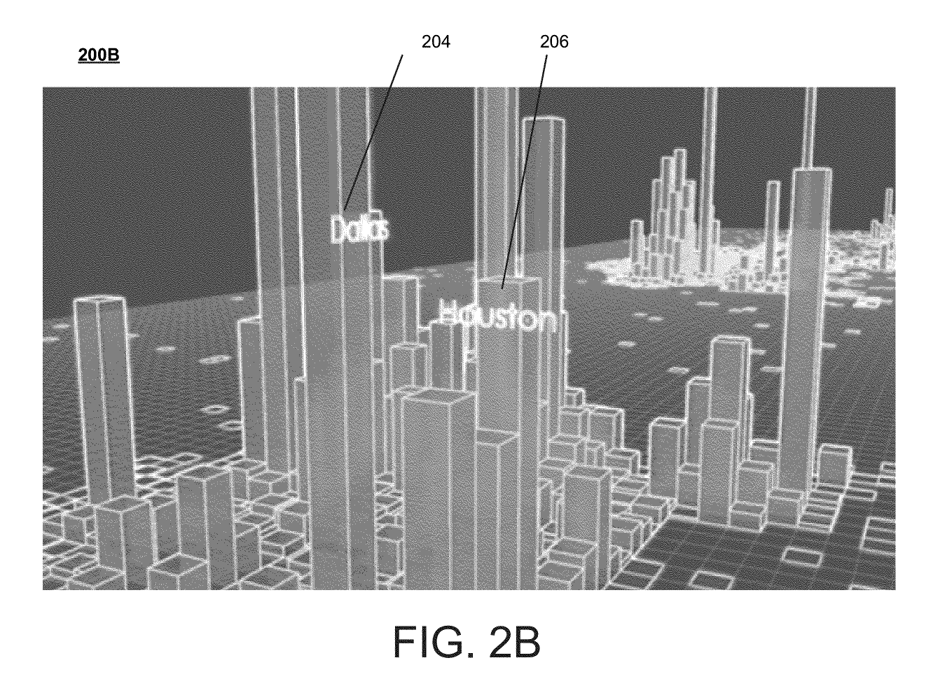

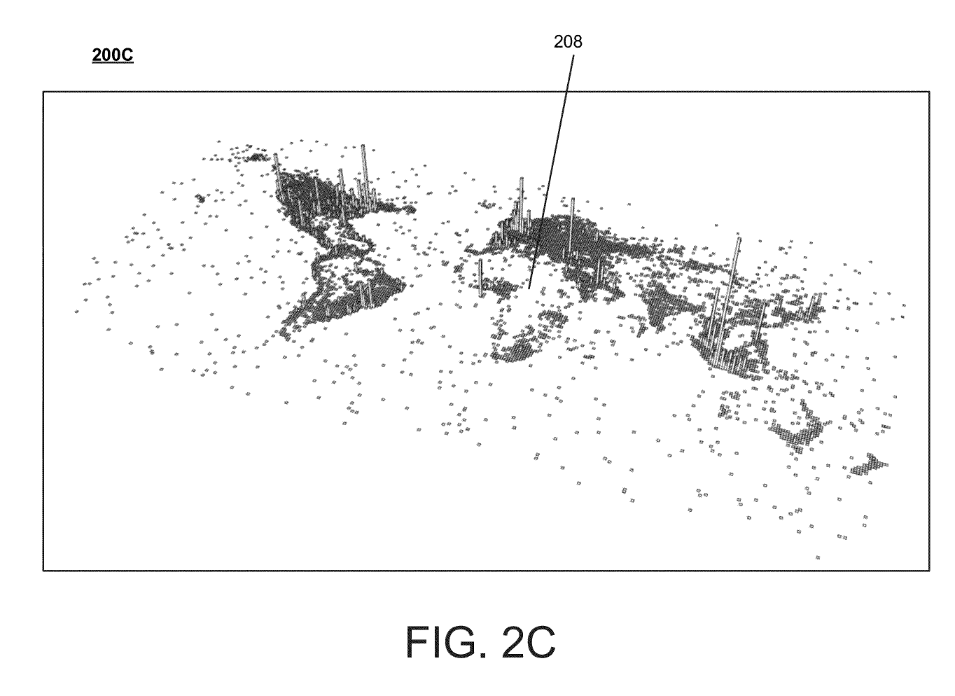

FIGS. 2A-2C depict example georepresentations of social media data. As shown in FIG. 2A, a screen capture 200A of an image from a fly-through video depicts another aspect of a georepresentation of the frequencies of TWEETs originating from various global geolocations on Jan. 1, 2013. As shown in FIG. 2A, the frequency of TWEETs originating from San Francisco, Calif. are depicted as a solid bar 202 having a height that is taller than other geolocations in a near vicinity, in the geographical area depicted in the screen capture 200A. As shown in FIG. 2B, the frequency of TWEETs originating from Dallas, Tex. and Houston, Tex. are depicted as solid bars 204 and 206, respectively, showing a height of the bar 204 (for Dallas) as taller than the bar 206 (for Houston), indicating that there were apparently more TWEETs logged that originated from the Dallas geographic area than from the Houston geographic area on Jan 1, 2013.

In accordance with example techniques discussed herein, there may be social media data that is received without valid geolocation data, which may, for example, be grouped in a set of data points with geographical coordinates set to NULL values (e.g., values of zero). For example, in the fly-through video, such a set of data points may be depicted as a bar with “(0, 0)” illustrating its geolocation.

As shown in FIG. 2C, a substantially flat view depicts another aspect of a georepresentation of the frequencies of TWEETs originating from the various global geolocations on January 1, 2013. As shown in FIG. 2C, a user may easily ascertain that there were very few, or no, TWEETs determined to have originated from some areas of Africa, as depicted by area 208.

In accordance with example techniques discussed herein, one skilled in the art of data processing will understand that there may be many other types of tangibilized representations of geocoded data. For example, as discussed further below, a user may generate 3-D tangible objects such as edible objects (e.g., cookies or other edible objects), knitted/crocheted objects, and any other type of 3-D tangible object that tangibly represents the 3-D data representation, without departing from the spirit of the discussion herein. For example, movable pins may be used for such representations.

One skilled in the art of data processing will appreciate that there may be many ways to accomplish the tangibilization of geocoded data discussed herein, without departing from the spirit of the discussion herein.

II. Example Operating Environment

Features discussed herein are provided as example embodiments that may be implemented in many different ways that may be understood by one of skill in the art of data processing, without departing from the spirit of the discussion herein. Such features are to be construed only as example embodiment features, and are not intended to be construed as limiting to only those detailed descriptions.

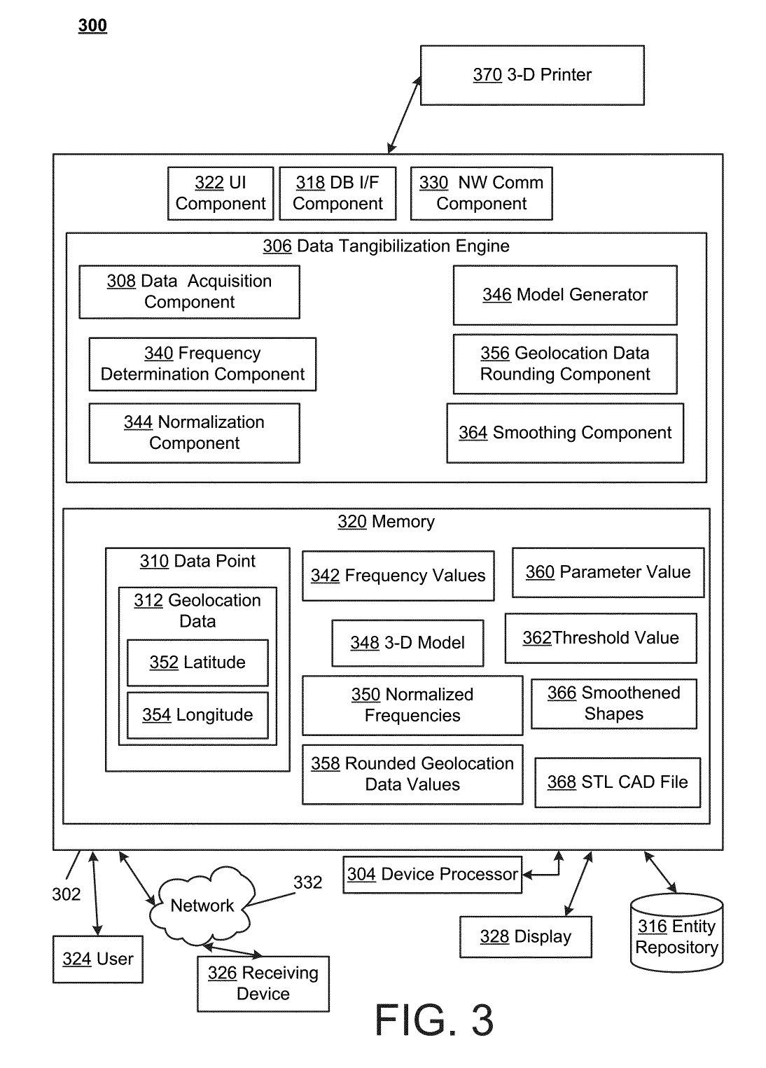

As further discussed herein, FIG. 3 is a block diagram of a system 300 for tangibilization of geocoded data. As shown in FIG. 3, a system 300 may include a device 302 that includes at least one processor 304. The device 302 may include a data tangibilization engine 306 that may include a data acquisition component 308 that may be configured to obtain a plurality of data points 310 that include geolocation data 312 associated with each respective obtained data point 310. For example, the data acquisition component 308 may obtain a machine readable data file containing at least latitude, and longitude columns for each row. For example, the format of the file may be comma-separated, tab-delimited values, or similar. One skilled in the art of data processing will understand that there are numerous forms of data input, without departing from the spirit of the discussion herein.

In this context, “geocoded data” may refer to any type of data that is coded with geolocation information. It is to be understood that this is not limited to data originating in a geographical environment, as various types of similarity and distance metrics may be used on many types of data to convert such raw data into points that may be virtualized to geolocation-type data (e.g., similarities of documents, similarities/differences among various entities, etc.). Further, such “geolocation data” may be associated with entities other than geographical maps. For example, the geolocation data may be associated with entities such as buildings, as well as other “non-natural” entities (e.g., via the “distances” and/or “similarities” between entities such as documents and other entities).

According to an example embodiment, the data tangibilization engine 306, or one or more portions thereof, may include executable instructions that may be stored on a tangible computer-readable storage medium, as discussed below. According to an example embodiment, the computer-readable storage medium may include any number of storage devices, and any number of storage media types, including distributed devices.

In this context, a “processor” may include a single processor or multiple processors configured to process instructions associated with a processing system. A processor may thus include one or more processors processing instructions in parallel and/or in a distributed manner. Although the device processor 304 is depicted as external to the data tangibilization engine 306 in FIG. 3, one skilled in the art of data processing will appreciate that the device processor 304 may be implemented as a single component, and/or as distributed units which may be located internally or externally to the data tangibilization engine 306, and/or any of its elements.

For example, the system 300 may include one or more processors 304. For example, the system 300 may include at least one tangible computer-readable storage medium storing instructions executable by the one or more processors 304, the executable instructions configured to cause at least one data processing apparatus to perform operations associated with various example components included in the system 300, as discussed herein. For example, the one or more processors 304 may be included in the at least one data processing apparatus. One skilled in the art of data processing will understand that there are many configurations of processors and data processing apparatuses that may be configured in accordance with the discussion herein, without departing from the spirit of such discussion.

In this context, a “component” may refer to instructions or hardware that may be configured to perform certain operations. Such instructions may be included within component groups of instructions, or may be distributed over more than one group. For example, some instructions associated with operations of a first component may be included in a group of instructions associated with operations of a second component (or more components). For example, a “component” herein may refer to a type of computational entity configured with functionality that may be implemented by instructions that may be located in a single entity, or may be spread or distributed over multiple entities, and may overlap with instructions and/or hardware associated with other components.

According to an example embodiment, the data tangibilization engine 306 may be implemented in association with one or more user devices. For example, the data tangibilization engine 306 may communicate with one or more servers, as discussed further below.

For example, an entity repository 316 may include one or more databases, and may be accessed via a database interface component 318. One skilled in the art of data processing will appreciate that there are many techniques for storing repository information discussed herein, such as various types of database configurations (e.g., relational databases, hierarchical databases, distributed databases) and non-database configurations.

According to an example embodiment, the data tangibilization engine 306 may include a memory 320 that may store the data points 310 (e.g., or a representation thereof). In this context, a “memory” may include a single memory device or multiple memory devices configured to store data and/or instructions. Further, the memory 320 may span multiple distributed storage devices.

According to an example embodiment, a user interface component 322 may manage communications between a user 324 and the data tangibilization engine 306. The user 324 may be associated with a receiving device 326 that may be associated with a display 328 and other input/output devices. For example, the display 328 may be configured to communicate with the receiving device 326, via internal device bus communications, or via at least one network connection.

According to example embodiments, the display 328 may be implemented as a flat screen display, a print form of display, a two-dimensional display, a three-dimensional display, a static display, a moving display, sensory displays such as tactile output, audio output, and any other form of output for communicating with a user (e.g., the user 324).

According to an example embodiment, the data tangibilization engine 306 may include a network communication component 330 that may manage network communication between the data tangibilization engine 306 and other entities that may communicate with the data tangibilization engine 306 via at least one network 332. For example, the network 332 may include at least one of the Internet, at least one wireless network, or at least one wired network. For example, the network 332 may include a cellular network, a radio network, or any type of network that may support transmission of data for the data tangibilization engine 306. For example, the network communication component 330 may manage network communications between the data tangibilization engine 306 and the receiving device 326. For example, the network communication component 330 may manage network communication between the user interface component 322 and the receiving device 326.

A frequency determination component 340 may be configured to determine a plurality of frequency values 342 depicting frequencies of sets of the obtained data points 310 that are associated with respective geolocations represented by the geolocation data 312. For example, for each unique latitude-longitude pair, a frequency of occurrences may be calculated. For example, the frequency may then indicate the number of rows in the input data that have the same rounded geolocation. As discussed further below, this frequency may be normalized by applying a logarithmic function to attenuate drastic changes in values.

A normalization component 344 may be configured to normalize the plurality of frequency values 342. For example, a result of the normalization may include a machine readable file (or set of normalized points) with, at least, frequency, latitude, and longitude values. For example, the normalization component may apply the natural logarithm function to the frequency values such that substantially larger frequency values are attenuated and do not eclipse smaller frequency values. One skilled in the art will understand that there are many techniques that may be used for such normalization (e.g., other logarithmic functions, etc.), without departing from the spirit of the discussion herein.

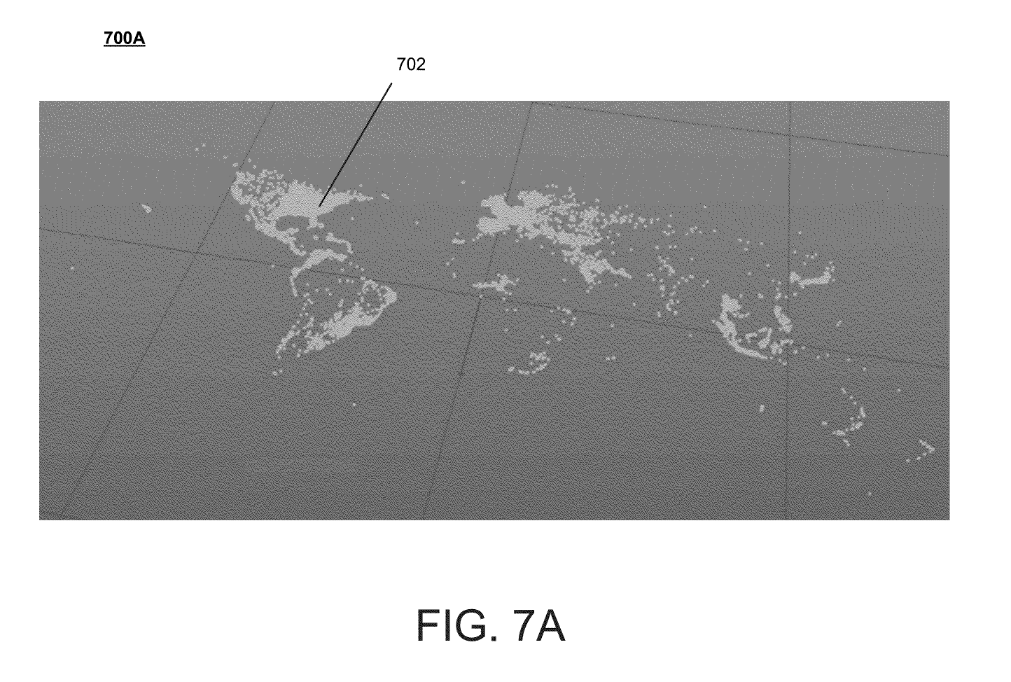

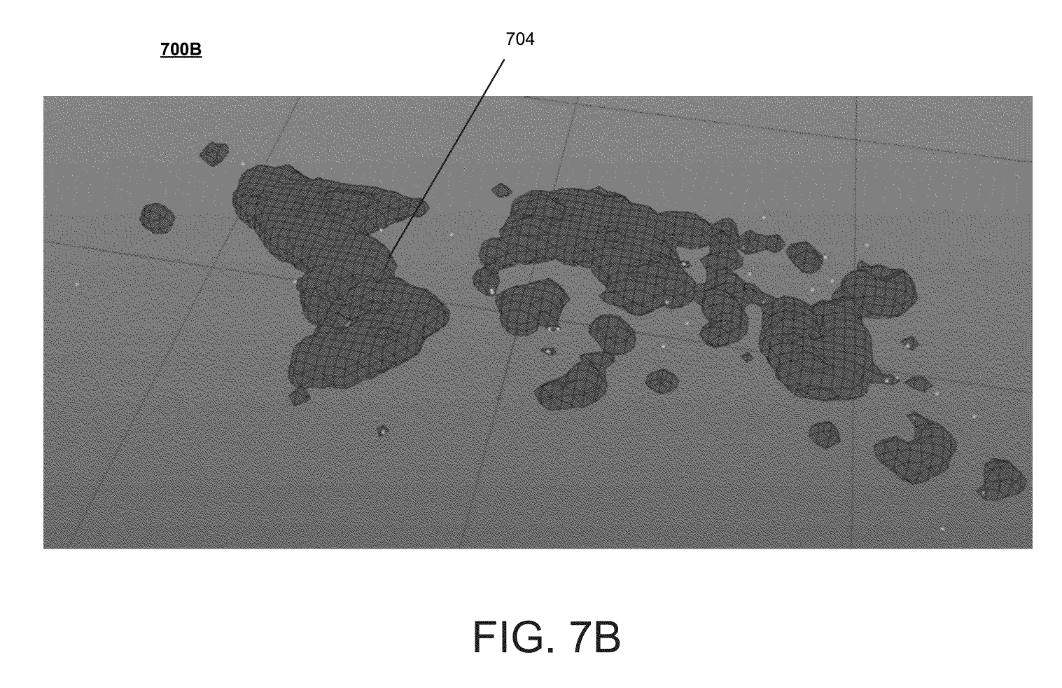

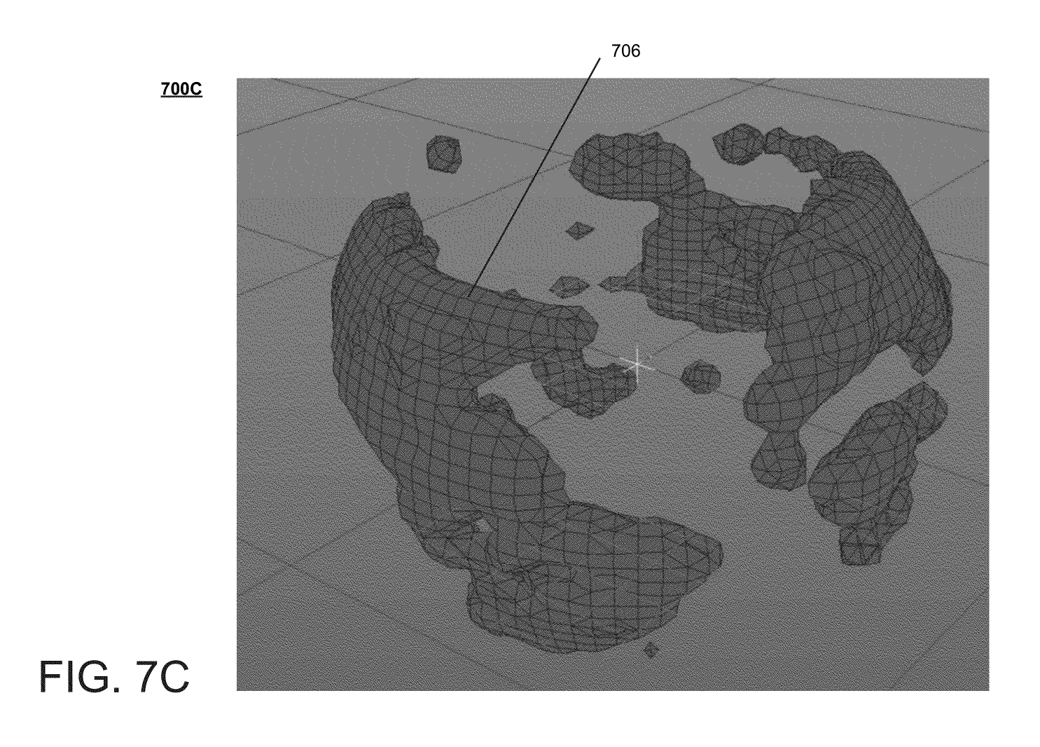

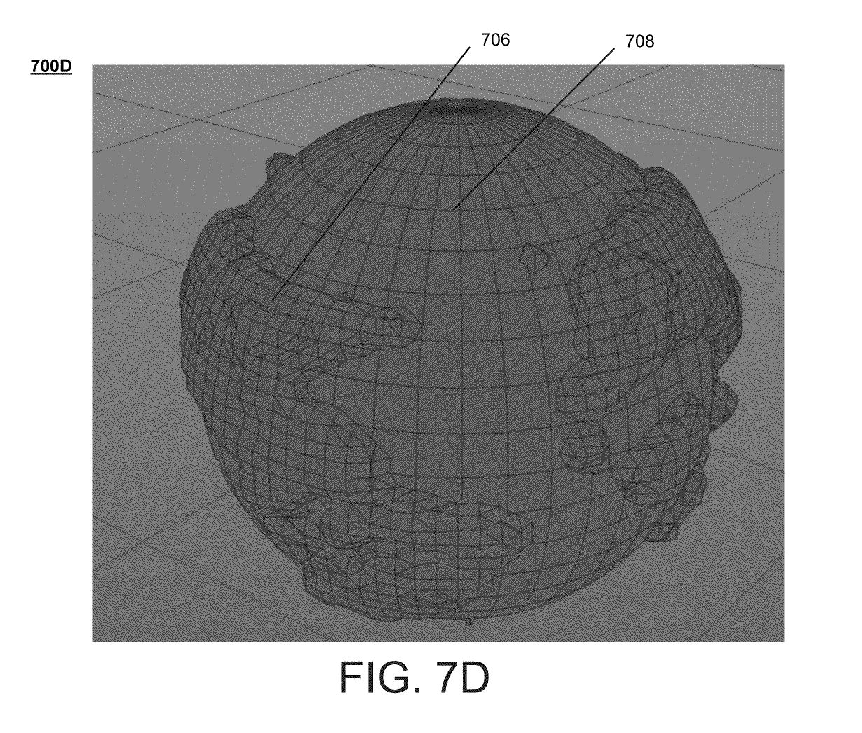

A model generator 346 may be configured to generate a tangible three-dimensional (3-D) model 348 using the geolocation data 312 to determine location perspective of the data points 310 on the 3-D model 348 for a mapping of the data points 310 to the 3-D model 348, and using the normalized frequency values 350 to determine heights of raised portions of the 3-D model 348 at locations of the respective mapped data points 310 on the 3-D model 348. For example, given the normalization result, a spherical digital model may be generated using the frequency as the height of a “mountain-like” representation, and respective latitude-longitude values may be used to determine the location of such “mountains” in the “mountain-like” representation. For example, as discussed further below, the shape of a “mountain” may be smoothened using various 3-D smoothening techniques, or may be left raw. In this context, “location perspective” generally refers to determining a mapping perspective for points to determine their pairwise proximities and pairwise positional perspective in the mapped model. As discussed further below, FIGS. 7A-7D depict an example sequence for generating the tangibilized georepresentation of FIG. 1, using 3-D smoothening techniques.

For example, the data acquisition component 308 may be configured to obtain the plurality of data points 310 that include geolocation data 312 associated with each respective obtained data point 310, wherein the geolocation data 312 includes a pair of latitude and longitude values 352, 354 for each of the obtained data points 310.

For example, a geolocation data rounding component 356 may be configured to determine rounded geolocation data values 358 for the obtained geolocation data 312.

For example, the obtained geolocation data 312 includes a respective pair of latitude and longitude values 352, 354 for each of the obtained data points 310.

For example, the geolocation data rounding component 356 may be configured to determine rounded values 358 for the respective pairs of latitude and longitude values 352, 354.

For example, the frequency determination component 340 may be configured to determine the plurality of frequency values 342 depicting frequencies of sets of the obtained data points 310 that are associated with respective geolocations represented by the geolocation data 312, using the rounded values 358 for the respective pairs of latitude and longitude values 352, 354 as the respective geolocations represented by the geolocation data 312.

For example, the geolocation data rounding component 356 may be configured to determine the rounded values 358 for the respective pairs of latitude and longitude values 352, 354, using a parameter value 360 that determines a granularity of the 3-D model 348, based on a number of decimal places in the rounded values 358 for the respective pairs of latitude and longitude values 352, 354, wherein an increase in the number of decimal places corresponds to an increase in granularity and an increase in thinness of relief points in the 3-D model 348.

For example, the normalization component 344 may be configured to normalize the plurality of frequency values 342 using a logarithmic function for attenuating differences in values among the determined frequency values 342 for difference values that exceed a predetermined threshold value 362.

For example, the geolocation data 312 includes a pair of latitude and longitude values 352, 354 for each of the obtained data points 310.

For example, the model generator 346 may be configured to generate the 3-D model 348 as a spherical digital 3-D model using the determined heights to generate digital raised portions in accordance with the determined heights, located at the locations of the respective mapped data points 310 on the 3-D model 348, that are located based on the location perspective of the data points 310, based on the respective pairs of latitude and longitude values 352, 354.

For example, a smoothing component 364 may be configured to determine smoothened shapes 366 for at least a subset of the digital raised portions.

For example, the model generator 346 may be configured to initiate conversion of the 3-D model 348 to a standard stereolithography (STL) computer-aided design (CAD) file format 368.

For example, the model generator 346 may be configured to initiate output of the 3-D model 348 to a 3-D printer 370.

For example, the system 300 may be realized as a service, or application, that users may access to obtain tangible representations of their geocoded data.

FIGS. 7A-7D depict an example sequence for generating the tangibilized georepresentation of FIG. 1. For example, FIG. 7A depicts a georepresentation of the points from the obtained data. For example, data points 702 depict data points determined as having geolocation data within the United States.

As shown in FIG. 7B, polygons such as polygon 704 may be generated, based on the obtained data points. As shown in FIG. 7B, the number of points determined as located within a particular area may increase the volume of the polygon in that particular area. For example, rendering techniques using “Metaballs” may be used for rendering such polygons (see, e.g., James F. Blinn, “A Generalization of Algebraic Surface Drawing,” ACM Transactions on Graphics (TOG), Vol. 1, Issue 3, July 1982, pages 235-256).

The resulting polygon(s) 706 may then be wrapped around a sphere 708, as shown in FIGS. 7C and 7D.

One skilled in the art of data processing will appreciate that many different techniques may be used for tangibilizing geocoded data, without departing from the spirit of the discussion herein.

III. Flowchart Description

Features discussed herein are provided as example embodiments that may be implemented in many different ways that may be understood by one of skill in the art of data processing, without departing from the spirit of the discussion herein. Such features are to be construed only as example embodiment features, and are not intended to be construed as limiting to only those detailed descriptions.

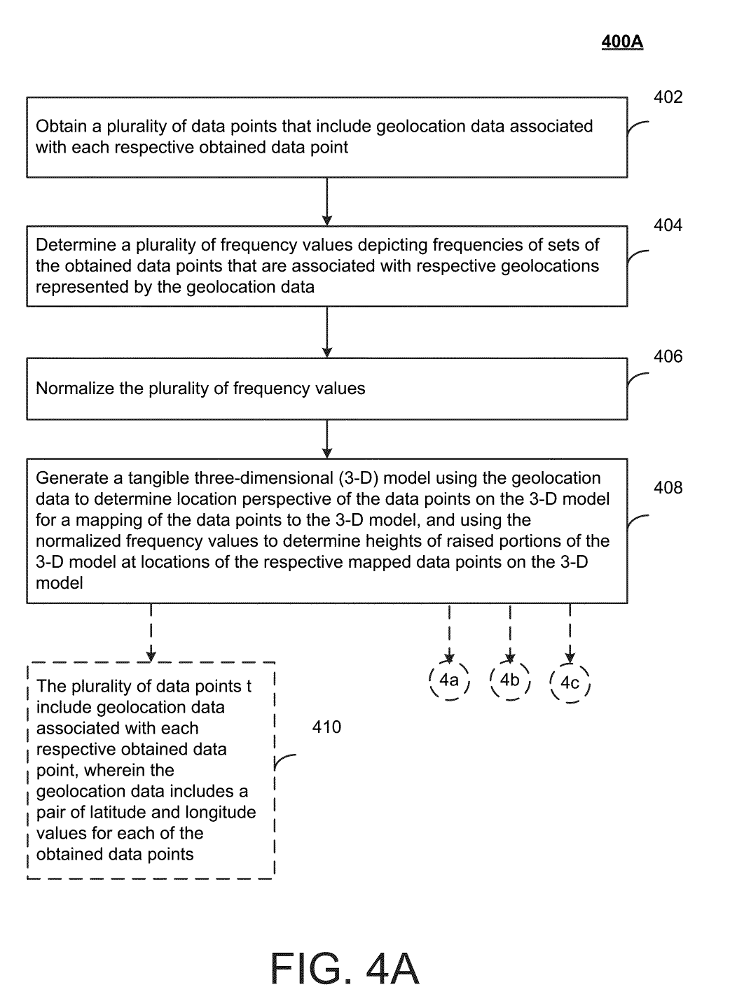

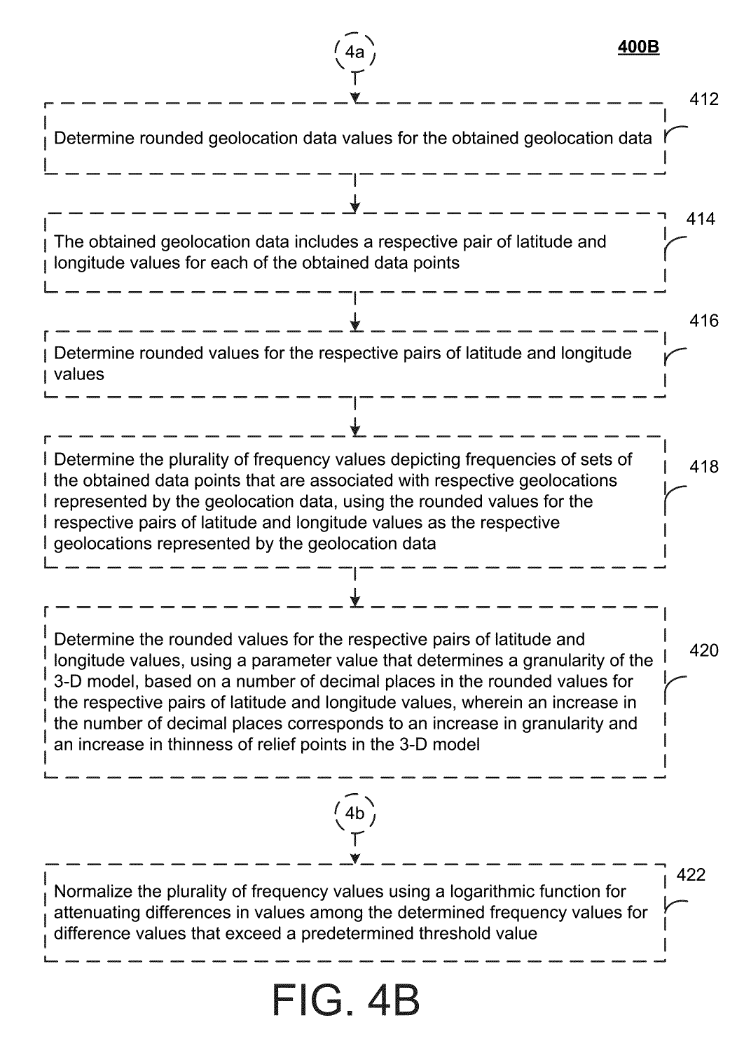

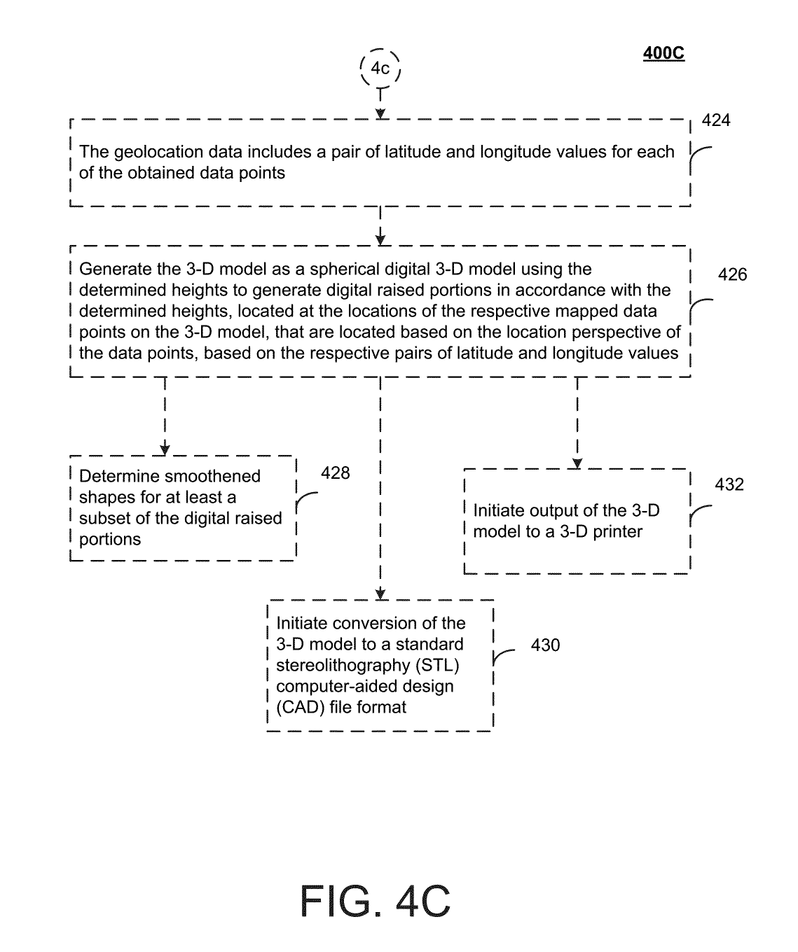

FIGS. 4A-4C are a flowchart illustrating example operations of the system of FIG. 3, according to example embodiments. In the example of FIG. 4A, a plurality of data points that include geolocation data associated with each respective obtained data point may be obtained (402). For example, the data acquisition component 308 may obtain the data points 310 that include the geolocation data 314, as discussed above.

A plurality of frequency values depicting frequencies of sets of the obtained points that are associated with respective geolocations represented by the geolocation data may be determined (404). For example, the frequency determination component 340 may determine the frequency values 342 depicting frequencies of sets of the obtained data points 310 that are associated with respective geolocations represented by the geolocation data 312, as discussed above.

The plurality of frequency values may be normalized (406). For example, the normalization component 340 may normalize the frequency values 342, as discussed above.

A tangible three-dimensional (3-D) model may be generated using the geolocation data to determine location perspective of the data points on the 3-D model for a mapping of the data points to the 3-D model, and using the normalized frequency values to determine heights of raised portions of the 3-D model at locations of the respective mapped data points on the 3-D model (408). For example, the model generator 346 may generate the tangible three-dimensional (3-D) model 348 using the geolocation data 312 to determine location perspective of the data points 310 on the 3-D model 348 for a mapping of the data points 310 to the 3-D model 348, and using the normalized frequency values 350 to determine heights of raised portions of the 3-D model 348 at locations of the respective mapped data points 310 on the 3-D model 348, as discussed above.

For example, the geolocation data may include a pair of latitude and longitude values for each of the obtained data points (410).

For example, rounded geolocation data values may be determined for the obtained geolocation data (412), in the example of FIG. 4B. For example, the geolocation data rounding component 356 may be configured to determine rounded geolocation data values 358 for the obtained geolocation data 312, as discussed above.

For example, the obtained geolocation data may include a respective pair of latitude and longitude values for each of the obtained data points (414).

For example, rounded values for the respective pairs of latitude and longitude values may be determined (416). For example, the geolocation data rounding component 356 may determine rounded values 358 for the respective pairs of latitude and longitude values 352, 354, as discussed above.

For example, the plurality of frequency values depicting frequencies of sets of the obtained data points that are associated with respective geolocations represented by the geolocation data may be determined, using the rounded values for the respective pairs of latitude and longitude values as the respective geolocations represented by the geolocation data (418). For example, the frequency determination component 340 may be configured to determine the plurality of frequency values 342 depicting frequencies of sets of the obtained data points 310 that are associated with respective geolocations represented by the geolocation data 312, using the rounded values 358 for the respective pairs of latitude and longitude values 352, 354 as the respective geolocations represented by the geolocation data 312, as discussed above.

For example, the rounded values for the respective pairs of latitude and longitude values may be determined, using a parameter value that determines a granularity of the 3-D model, based on a number of decimal places in the rounded values for the respective pairs of latitude and longitude values, wherein an increase in the number of decimal places corresponds to an increase in granularity and an increase in thinness of relief points in the 3-D model (420). For example, the geolocation data rounding component 356 may determine the rounded values 358 for the respective pairs of latitude and longitude values 352, 354, using the parameter value 360 that determines the granularity of the 3-D model 348, as discussed above.

For example, the plurality of frequency values may be normalized using a logarithmic function for attenuating differences in values among the determined frequency values for difference values that exceed a predetermined threshold value (422). For example, the normalization component 344 may normalize the plurality of frequency values 342 using a logarithmic function for attenuating differences in values among the determined frequency values 342 for difference values that exceed a predetermined threshold value 362, as discussed above.

For example, the geolocation data includes a pair of latitude and longitude values for each of the obtained data points (424), in the example of FIG. 4C.

For example, the 3-D model may be generated as a spherical digital 3-D model using the determined heights to generate digital raised portions in accordance with the determined heights, located at the locations of the respective mapped data points on the 3-D model, that are located based on the location perspective of the data points, based on the respective pairs of latitude and longitude values (426). For example, the model generator 346 may generate the 3-D model 348 as a spherical digital 3-D model using the determined heights to generate digital raised portions in accordance with the determined heights, located at the locations of the respective mapped data points 310 on the 3-D model 348, that are located based on the location perspective of the data points 310, based on the respective pairs of latitude and longitude values 352, 354, as discussed above.

For example, smoothened shapes may be determined for at least a subset of the digital raised portions (428). For example, the smoothing component 364 may determine smoothened shapes 366 for at least a subset of the digital raised portions, as discussed above.

For example, conversion of the 3-D model to a standard stereolithography (STL) computer-aided design (CAD) file format may be initiated (430). For example, the model generator 346 may initiate conversion of the 3-D model 348 to a standard stereolithography (STL) computer-aided design (CAD) file format 368, as discussed above.

For example, output of the 3-D model to a 3-D printer may be initiated (432). For example, the model generator 346 may initiate output of the 3-D model 348 to a 3-D printer 370, as discussed above.

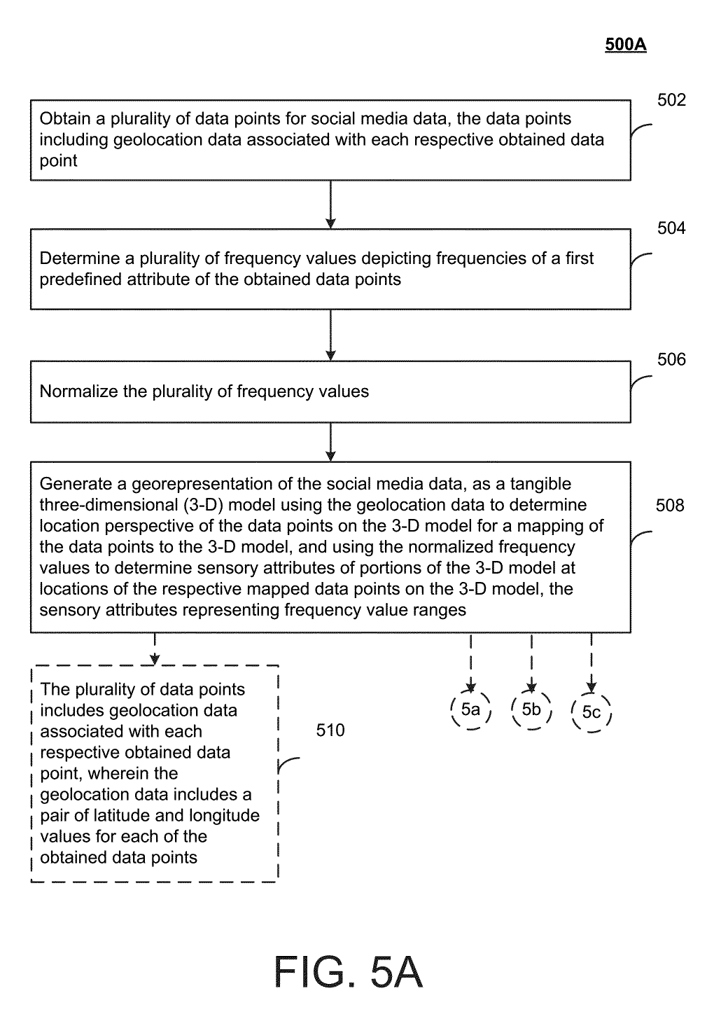

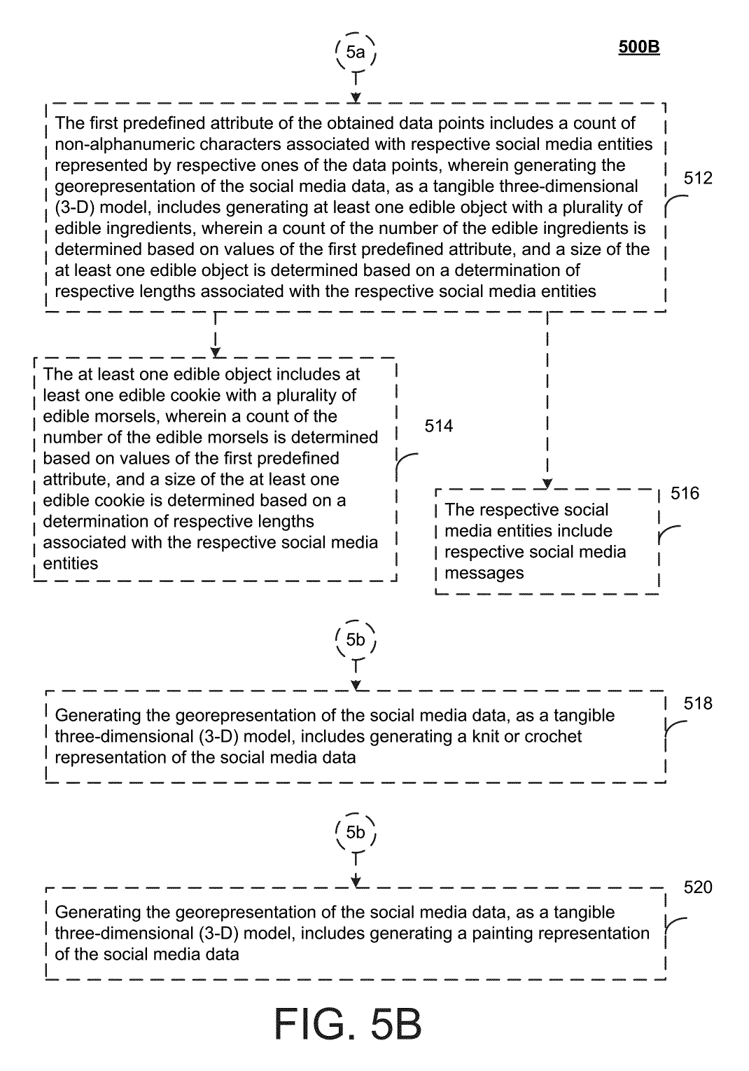

FIGS. 5A-5B are a flowchart illustrating example operations of the system of FIG. 3, according to example embodiments. In the example of FIG. 5A, a plurality of data points for social media data, the data points including geolocation data associated with each respective obtained data point, may be obtained (502). For example, the data acquisition component 308 may obtain the data points 310 that include the geolocation data 314, as discussed above.

A plurality of frequency values depicting frequencies of a first predefined attribute of the obtained data points may be determined (504). For example, the frequency determination component 340 may determine the frequency values 342 depicting frequencies of sets of the obtained data points 310 that are associated with respective geolocations represented by the geolocation data 312, as discussed above.

The plurality of frequency values may be normalized (506). For example, the normalization component 340 may normalize the frequency values 342, as discussed above.

A georepresentation of the social media data may be generated as a tangible three-dimensional (3-D) model using the geolocation data to determine location perspective of the data points on the 3-D model for a mapping of the data points to the 3-D model, and using the normalized frequency values to determine sensory attributes of portions of the 3-D model at locations of the respective mapped data points on the 3-D model, the sensory attributes representing frequency value ranges (508). For example, the model generator 346 may generate the tangible three-dimensional (3-D) model 348 using the geolocation data 312 to determine location perspective of the data points 310 on the 3-D model 348 for a mapping of the data points 310 to the 3-D model 348, as discussed above.

For example, the geolocation data may include a pair of latitude and longitude values for each of the obtained data points (510).

For example, the first predefined attribute of the obtained points may include a count of non-alphanumeric characters associated with respective social media entities represented by respective ones of the data points, wherein generating the georepresentation of the social media data, as a tangible three-dimensional (3-D) model, may include generating at least one edible object with a plurality of edible ingredients, wherein a count of the number of the edible ingredients is determined based on values of the first predefined attribute, and a size of the at least one edible object may be determined based on a determination of respective lengths associated with the respective social media entities (512), in the example of FIG. 5B.

For example, the at least one edible object may include at least one edible cookie with a plurality of edible morsels, wherein a count of the number of the edible morsels may be determined based on values of the first predefined attribute, and a size of the at least one edible cookie may be determined based on a determination of respective lengths associated with the respective social media entities (514). For example, the morsels may include flavored chips such as chocolate chips (or butterscotch chips, sprinkles, etc.). One skilled in the art will appreciate that there are many other types of morsels that may be used, without departing from the spirit of the discussion herein.

For example, the respective social media entities may include respective social media messages (516).

For example, generating the georepresentation of the social media data, as a tangible three-dimensional (3-D) model, may include generating a knit or crochet representation of the social media data (518). For example, the social media data may be converted into a color representation, which may then be graphed using neighborhoods of a particular geographic area (e.g., Seattle, etc.). Each neighborhood may then be represented with a particular knitting or crochet pattern.

For example, generating the georepresentation of the social media data, as a tangible three-dimensional (3-D) model, may include generating a painting representation of the social media data (520). For example, the painting representation may be determined based on perceived “peaks” of data. For example, colors in the painting representation may indicate a significance corresponding to the frequency of which these colors are mentioned in the transmissions (e.g., message transmissions, phone calls, etc.) of a particular geographic area (e.g., a neighborhood, etc.). For example, a size of an area of a particular color may indicate a relative frequency of the mentions of that particular color in the transmissions.

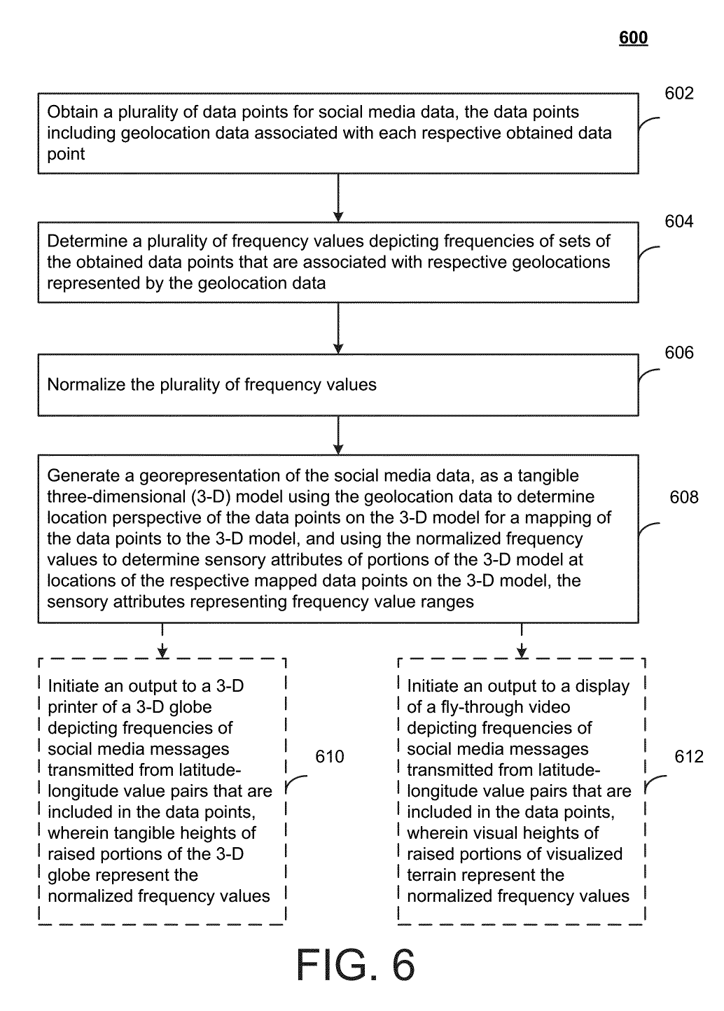

FIG. 6 is a flowchart illustrating example operations of the system of FIG. 3, according to example embodiments. In the example of FIG. 6, a plurality of data points for social media data, the data points including geolocation data associated with each respective obtained data point, may be obtained (602). For example, the data acquisition component 308 may obtain the data points 310 that include the geolocation data 314, as discussed above.

A plurality of frequency values depicting frequencies of sets of the obtained data points that are associated with respective geolocations represented by the geolocation data may be determined (604). For example, the frequency determination component 340 may determine the frequency values 342 depicting frequencies of sets of the obtained data points 310 that are associated with respective geolocations represented by the geolocation data 312, as discussed above.

The plurality of frequency values may be normalized (606). For example, the normalization component 340 may normalize the frequency values 342, as discussed above.

A georepresentation of the social media data may be generated as a tangible three-dimensional (3-D) model using the geolocation data to determine location perspective of the data points on the 3-D model for a mapping of the data points to the 3-D model, and using the normalized frequency values to determine sensory attributes of portions of the 3-D model at locations of the respective mapped data points on the 3-D model, the sensory attributes representing frequency value ranges (508). For example, the model generator 346 may generate the tangible three-dimensional (3-D) model 348, as discussed above.

For example, an output may be initiated to a 3-D printer, of a 3-D globe (or other type of object representing location data) depicting frequencies of social media messages transmitted from latitude-longitude value pairs that are included in the data points, wherein tangible heights of raised portions of the 3-D globe represent the normalized frequency values (610). For example, the model generator 346 may initiate output of the 3-D model 348 to a 3-D printer 370, as discussed above.

For example, an output may be initiated to a 3-D display, of a fly-through video depicting frequencies of social media messages transmitted from latitude-longitude longitude value pairs that are included in the data points, wherein visual heights of raised portions of visualized terrain represent the normalized frequency values (610). For example, the model generator 346 may initiate output of the 3-D model 348, as discussed above.

One skilled in the art of data processing will understand that there may be many ways of performing tangibilization of geocoded data, without departing from the spirit of the discussion herein.

Customer privacy and confidentiality have been ongoing considerations in data processing environments for many years. Thus, example techniques for tangibilization of geocoded data may use user input and/or data provided by users who have provided permission via one or more subscription agreements (e.g., “Terms of Service” (TOS) agreements) with associated applications or services associated with such validation. For example, users may provide consent to have their input/data transmitted and stored on devices, though it may be explicitly indicated (e.g., via a user accepted agreement) that each party may control how transmission and/or storage occurs, and what level or duration of storage may be maintained, if any. It is to be understood that any user input/data may be obtained in accordance with the privacy laws and regulations of any relevant jurisdiction.

Implementations of the various techniques described herein may be implemented in digital electronic circuitry, or in computer hardware, firmware, software, or in combinations of them (e.g., an apparatus configured to execute instructions to perform various functionality).

Implementations may be implemented as a computer program embodied in a pure signal such as a pure propagated signal. Such implementations will be referred to herein as implemented via a “computer-readable transmission medium.”

Alternatively, implementations may be implemented as a computer program embodied in a machine usable or machine readable storage device (e.g., a magnetic or digital medium such as a Universal Serial Bus (USB) storage device, a tape, hard disk drive, compact disk, digital video disk (DVD), etc.), for execution by, or to control the operation of, data processing apparatus, e.g., a programmable processor, a computer, or multiple computers. Such implementations may be referred to herein as implemented via a “computer-readable storage medium” or a “computer-readable storage device” and are thus different from implementations that are purely signals such as pure propagated signals.

A computer program, such as the computer program(s) described above, can be written in any form of programming language, including compiled, interpreted, or machine languages, and can be deployed in any form, including as a stand-alone program or as a module, component, subroutine, or other unit suitable for use in a computing environment. The computer program may be tangibly embodied as executable code (e.g., executable instructions) on a machine usable or machine readable storage device (e.g., a computer-readable medium). A computer program that might implement the techniques discussed above may be deployed to be executed on one computer or on multiple computers at one site or distributed across multiple sites and interconnected by a communication network.

Method steps may be performed by one or more programmable processors executing a computer program to perform functions by operating on input data and generating output. The one or more programmable processors may execute instructions in parallel, and/or may be arranged in a distributed configuration for distributed processing. Example functionality discussed herein may also be performed by, and an apparatus may be implemented, at least in part, as one or more hardware logic components. For example, and without limitation, illustrative types of hardware logic components that may be used may include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Processors suitable for the execution of a computer program include, by way of example, both general and special purpose microprocessors, and any one or more processors of any kind of digital computer. Generally, a processor will receive instructions and data from a read only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto optical disks, or optical disks. Information carriers suitable for embodying computer program instructions and data include all forms of nonvolatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT), liquid crystal display (LCD), or plasma monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback. For example, output may be provided via any form of sensory output, including (but not limited to) visual output (e.g., visual gestures, video output), audio output (e.g., voice, device sounds), tactile output (e.g., touch, device movement), temperature, odor, etc.

Further, input from the user can be received in any form, including acoustic, speech, or tactile input. For example, input may be received from the user via any form of sensory input, including (but not limited to) visual input (e.g., gestures, video input), audio input (e.g., voice, device sounds), tactile input (e.g., touch, device movement), temperature, odor, etc.

Further, a natural user interface (NUI) may be used to interface with a user. In this context, a “NUI” may refer to any interface technology that enables a user to interact with a device in a “natural” manner, free from artificial constraints imposed by input devices such as mice, keyboards, remote controls, and the like.

Examples of NUI techniques may include those relying on speech recognition, touch and stylus recognition, gesture recognition both on a screen and adjacent to the screen, air gestures, head and eye tracking, voice and speech, vision, touch, gestures, and machine intelligence. Example NUI technologies may include, but are not limited to, touch sensitive displays, voice and speech recognition, intention and goal understanding, motion gesture detection using depth cameras (e.g., stereoscopic camera systems, infrared camera systems, RGB (red, green, blue) camera systems and combinations of these), motion gesture detection using accelerometers/gyroscopes, facial recognition, 3D displays, head, eye, and gaze tracking, immersive augmented reality and virtual reality systems, all of which may provide a more natural interface, and technologies for sensing brain activity using electric field sensing electrodes (e.g., electroencephalography (EEG) and related techniques).

Implementations may be implemented in a computing system that includes a back end component, e.g., as a data server, or that includes a middleware component, e.g., an application server, or that includes a front end component, e.g., a client computer having a graphical user interface or a Web browser through which a user can interact with an implementation, or any combination of such back end, middleware, or front end components. Components may be interconnected by any form or medium of digital data communication, e.g., a communication network. Examples of communication networks include a local area network (LAN) and a wide area network (WAN), e.g., the Internet.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A system comprising:
a device that includes at least one processor, the device including a data tangibilization engine comprising instructions tangibly embodied on a computer readable storage medium for execution by the at least one processor, the data tangibilization engine including:
a data acquisition component configured to obtain a plurality of data points that include geolocation data associated with each respective obtained data point;
a frequency determination component configured to determine, via at least one of the at least one processors, a plurality of frequency values depicting frequencies of sets of the obtained data points that are associated with respective geolocations represented by the geolocation data;
a normalization component configured to normalize the plurality of frequency values; and
a model generator configured to generate a tangible three-dimensional (3-D) model using the geolocation data to determine location perspective of the data points on the 3-D model for a mapping of the data points to the 3-D model, and using the normalized frequency values to determine heights of raised portions of the 3-D model at locations of the respective mapped data points on the 3-D model.

2. The system of claim 1, wherein:
the data acquisition component is configured to obtain the plurality of data points that include geolocation data associated with each respective obtained data point, wherein the geolocation data includes a pair of latitude and longitude values for each of the obtained data points.

3. The system of claim 1, further comprising:
a geolocation data rounding component configured to determine rounded geolocation data values for the obtained geolocation data.

4. The system of claim 3, wherein:
the obtained geolocation data includes a respective pair of latitude and longitude values for each of the obtained data points,
the geolocation data rounding component is configured to determine rounded values for the respective pairs of latitude and longitude values, and
the frequency determination component is configured to determine the plurality of frequency values depicting frequencies of sets of the obtained data points that are associated with respective geolocations represented by the geolocation data, using the rounded values for the respective pairs of latitude and longitude values as the respective geolocations represented by the geolocation data.

5. The system of claim 4, wherein:
the geolocation data rounding component is configured to determine the rounded values for the respective pairs of latitude and longitude values, using a parameter value that determines a granularity of the 3-D model, based on a number of decimal places in the rounded values for the respective pairs of latitude and longitude values, wherein an increase in the number of decimal places corresponds to an increase in granularity and an increase in thinness of relief points in the 3-D model.

6. The system of claim 1, wherein:
the normalization component is configured to normalize the plurality of frequency values using a logarithmic function for attenuating differences in values among the determined frequency values for difference values that exceed a predetermined threshold value.

7. The system of claim 1, wherein:
the geolocation data includes a pair of latitude and longitude values for each of the obtained data points, and
the model generator is configured to generate the 3-D model as a spherical digital 3-D model using the determined heights to generate digital raised portions in accordance with the determined heights, located at the locations of the respective mapped data points on the 3-D model, that are located based on the location perspective of the data points, based on the respective pairs of latitude and longitude values.

8. The system of claim 7, further comprising:
a smoothing component configured to determine smoothened shapes for at least a subset of the digital raised portions.

9. The system of claim 7, wherein:
the model generator is configured to initiate conversion of the 3-D model to a standard stereolithography (STL) computer-aided design (CAD) file format.

10. The system of claim 7, wherein:
the model generator is configured to initiate output of the 3-D model to a 3-D printer.

11. A method comprising:
obtaining a plurality of data points for social media data, the data points including geolocation data associated with each respective obtained data point;
determining, via a device processor, a plurality of frequency values depicting frequencies of a first predefined attribute of the obtained data points;
normalizing the plurality of frequency values; and
generating a georepresentation of the social media data, as a tangible three-dimensional (3-D) model using the geolocation data to determine location perspective of the data points on the 3-D model for a mapping of the data points to the 3-D model, and using the normalized frequency values to determine sensory attributes of portions of the 3-D model at locations of the respective mapped data points on the 3-D model, the sensory attributes representing frequency value ranges.

12. The method of claim 11, wherein:
the plurality of data points includes geolocation data associated with each respective obtained data point, wherein the geolocation data includes a pair of latitude and longitude values for each of the obtained data points.

13. The method of claim 11, wherein:
the first predefined attribute of the obtained points includes a count of non-alphanumeric characters associated with respective social media entities represented by respective ones of the data points, wherein generating the georepresentation of the social media data, as a tangible three-dimensional (3-D) model, includes generating at least one edible object with a plurality of edible ingredients, wherein a count of the number of the edible ingredients is determined based on values of the first predefined attribute, and a size of the at least one edible object is determined based on a determination of respective lengths associated with the respective social media entities.

14. The method of claim 13, wherein:
the at least one edible object includes at least one edible cookie with a plurality of edible morsels, wherein a count of the number of the edible morsels is determined based on values of the first predefined attribute, and
a size of the at least one edible cookie is determined based on a determination of respective lengths associated with the respective social media entities.

15. The method of claim 13, wherein:
the respective social media entities include respective social media messages.

16. The method of claim 11, wherein:
generating the georepresentation of the social media data, as a tangible three-dimensional (3-D) model, includes generating a knit or crochet representation of the social media data.

17. The method of claim 11, wherein:
generating the georepresentation of the social media data, as a tangible three-dimensional (3-D) model, includes generating a painting representation of the social media data.

18. A computer program product tangibly embodied on a computer-readable storage medium and comprising executable code that causes at least one data processing apparatus to:
obtain a plurality of data points for social media data, the data points including geolocation data associated with each respective obtained data point;
determine, via a device processor, a plurality of frequency values depicting frequencies of sets of the obtained data points that are associated with respective geolocations represented by the geolocation data;
normalize the plurality of frequency values; and
generate a georepresentation of the social media data, as a tangible three-dimensional (3-D) model using the geolocation data to determine location perspective of the data points on the 3-D model for a mapping of the data points to the 3-D model, and using the normalized frequency values to determine sensory attributes of portions of the 3-D model at locations of the respective mapped data points on the 3-D model, the sensory attributes representing frequency value ranges.

19. The computer program product of claim 18, wherein the executable code causes the at least one data processing apparatus to:
initiating an output to a 3-D printer of a 3-D globe depicting frequencies of social media messages transmitted from latitude-longitude value pairs that are included in the data points, wherein tangible heights of raised portions of the 3-D globe represent the normalized frequency values.

20. The computer program product of claim 18, wherein the executable code causes the at least one data processing apparatus to:
initiating an output to a display of a fly-through video depicting frequencies of social media messages transmitted from latitude-longitude value pairs that are included in the data points, wherein visual heights of raised portions of visualized terrain represent the normalized frequency values.
